(19) United States
(12) Patent Application Publication
(10) Pub. No.: US 2010/0060626 A1
(43) Pub. Date: Mar. 11, 2010

(54) Pixel circuit of active matrix organic light emitting diode

(75) Inventors: Shih-Chang Wang, Miao-Li (TW); Hong-Gi Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/387,975

(22) Filed: May 11, 2009

(30) Foreign Application Priority Data
Sep. 9, 2008 (TW) 97117133

(51) Int. Cl. G09G 5/00; G09G 3/32

(52) U.S. Cl. 345/214; 345/82

(57) ABSTRACT

A pixel circuit of an active matrix organic light emitting diode (AMOLED) device includes a scan line, a data line, a first switching thin film transistor (TFT), a capacitor connected between a drain electrode of the first switching TFT and ground, an organic light emitting diode, a driving TFT, and a control circuit. A gate electrode and a source electrode of the first switching TFT are respectively connected to the scan line and the data line. A gate electrode of the driving TFT is connected to a drain electrode of the first switching TFT, and a driving current is applied to the organic light emitting diode via the driving TFT. The control circuit connected to the data line detects a voltage value of the driving current, and regulates a voltage value of the data signal according to the voltage value of the driving current.

### BACKGROUND

1. Technical Field

The present disclosure relates to a pixel circuit, and more particularly to a pixel circuit of an active matrix organic light emitting diode (AMOLED) device.

2. Description of Related Art

Organic light emitting diode (OLED) devices typically have an anode, a cathode, and one or more layers of semiconductor organic material sandwiched between the anode and the cathode. An electric current is applied to the OLED device, causing negatively charged electrons to move into the organic material from the cathode. Positive charges, typically referred to as holes, move in from the anode. The positive and negative charges meet in the semiconductive organic material, combine and produce photons. The wavelength of the photons depends on the electronic properties of the semiconductive organic material.

According to driving methods, there are two categories of the OLED devices, passive matrix OLED (PMOLED) devices and AMOLED devices. For the PMOLED device, each organic light emitting diode is provided with a driving current for only one scan period in one frame and is turned off until beginning of the scan period in subsequent frame. Each organic light emitting diode emits light strong enough in each short scan period to achieve a satisfactory overall level of illumination. Thus, high driving current is necessary. However, such a high driving current shortens the lifetime of the organic light emitting diodes and consumes excessive power. Accordingly, the PMOLED device is used only in small devices, such as those requiring a display no more than 3.5 to 5 inches.

An AMOLED device avoids the described drawbacks by using thin film transistors (TFTs) coupled with capacitors to store electrical energy, with the capacitors charged by a driving current during a scan period and maintaining voltages thereon until the scan period of the subsequent frame. Thus, the organic light emitting diodes of the AMOLED device are turned on for a longer time period, and driving current can be lower than that of the PMOLED device. Correspondingly, the AMOLED device can be used in larger devices.

However, because of differences in the fabrication technologies of TFTs, threshold values in each pixel thereof are different. Even if the same data voltages are applied to the pixels, the driving currents through the corresponding organic light emitting diodes are different, such that the corresponding pixels achieve different brightnesses. Thus, image uniformity of the AMOLED device is limited.

What is needed, therefore, is a pixel circuit of an AMOLED device that can overcome the limitations described.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a pixel circuit diagram of a first embodiment of an AMOLED device according to the present disclosure.

FIG. 2 is a pixel circuit diagram of a second embodiment of an AMOLED device according to the present disclosure.

FIG. 3 is a pixel circuit diagram of a third embodiment of an AMOLED device according to the present disclosure.

### DETAILED DESCRIPTION

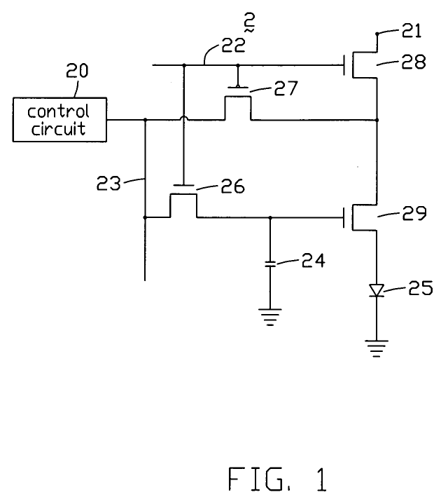

Referring to FIG. 1, a pixel circuit 2 of a first embodiment of an active matrix organic light emitting diode (AMOLED) device according to the present disclosure is shown. The pixel circuit 2 includes a control circuit 20, a voltage input terminal 21, a scan line 22, a data line 23, a capacitor 24, an organic light emitting diode 25, a first switching thin film transistor (TFT) 26, a second switching TFT 27, a third switching TFT 28, and a driving TFT 29. The first and third switching TFTs 26, 28 and the driving TFT 29 are n-channel type semiconductors, and the second switching TFT 27 is a p-channel type semiconductor. The voltage input terminal 21 provides a power voltage signal V_{D} to the pixel circuit 2.

The control circuit 20 is connected to the data line 23, and operable to control data signals transmitted by the data line 23. Gate electrodes (not labeled) of the first, second and third switching TFTs 26, 27 and 28 are connected to the same scan line 22. A source electrode (not labeled) and a drain electrode (not labeled) of the first switching TFT 26 are respectively connected to the data line 23 and a gate electrode (not labeled) of the driving TFT 29. A source electrode (not labeled) and a drain electrode (not labeled) of the second switching TFT 27 are respectively connected to the data line 23 and a source electrode (not labeled) of the driving TFT 29. A source electrode (not labeled) and a drain electrode (not labeled) of the third switching TFT 28 are respectively connected to the voltage input terminal 21 and the source electrode of the driving TFT 29. A drain electrode (not labeled) of the driving TFT 29 is grounded via an anode and a cathode of the organic light emitting diode 25 in sequence. The capacitor 24 is connected between the gate electrode of the driving TFT 29 and ground.

When the scan line 22 first outputs a high level, such as logic “1”, the first and third switching TFTs 26 and 28 are switched on, and the second switching TFT 27 is switched off. A data signal is applied to the drain electrode of the first switching TFT 26 via the data line 23 and the source electrode of the first switching TFT 26 to charge the capacitor 24. Meanwhile, the gate electrode of the driving TFT 29 receives a driving voltage of the same value as the data signal, causing the driving TFT 29 to be switched on. The power voltage signal V_{D} is applied to the drain electrode of the driving TFT 29 via the third switching TFT 28, so that a driving current I_{OLED} is transmitted to the organic light emitting diode 25. The value of the driving current I_{OLED} satisfies the formula:

I_{OLED}=k(V_{S}−V_{G}−V_{TH})²/2=k(V_{D}−V_{G}−V_{TH})²/2, and

k=μCoxW/L,

wherein V_{S} denotes a voltage of the drain electrode of the driving TFT 29, V_{G} denotes a voltage of the gate electrode of the driving TFT 29, V_{TH} denotes a threshold voltage of the driving TFT 29, k denotes a conductivity of the driving TFT 29, μ denotes mobility of the driving TFT 29, Cox denotes gate capacitance, W denotes a channel width of the driving TFT 29, and L denotes a channel length of the driving TFT 29.

When the high level first output by the scan line 22 is converted to a low level, such as a logic 0, the first and third switching TFTs 26 and 28 are switched off, and the second switching TFT 27 is switched on. At this moment, the control circuit 20 provides a voltage signal equaling the power voltage signal V_{D} to the data line 23, causing the voltage signal to be applied to the source electrode of the driving TFT 29 rather than the voltage input terminal 21. Meanwhile, the capacitor 24 discharges, and provides a control voltage to the gate electrode of the driving TFT 29 to switch on the driving TFT 29. The value of the driving current I_{OLED} through the organic light emitting diode 25 is still equal to about k(V_{D}−V_{G}−V_{TH})²/2.

At the same time, the control circuit 20 detects the present driving current I_{OLED} via the data line 23, and compares the present driving current I_{OLED} to a default value equal to about I=k(V_{D}−V_{G})²/2. The control circuit 20 calculates the threshold voltage V_{TH} according to a difference value between the present driving current I_{OLED} and the default value. To eliminate the effect of the threshold voltage V_{TH}, the data signal applied to the data line 23 needs to be compensated to V_{G}−V_{TH}. After calculating the difference value, the control circuit 20 stops to detect the present driving current I_{OLED}.

When a next high level is applied to the scan line 22, the first and third switching TFTs 26 and 28 are switched on, and the second switching TFT 27 is switched off. The data signal applied to the data line 23 is regulated by the control circuit 20, and has a value of about V_{G}−V_{TH}. The regulated data signal is applied to the drain electrode of the first switching TFT 26 via the data line 23 and the source electrode of the first switching TFT 26 to charge the capacitor 24. Meanwhile, the power voltage signal V_{D} is applied to the drain electrode of the driving TFT 29 via the third switching TFT 28, such that a driving current I_{OLED} is transmitted to the organic light emitting diode 25. The value of the driving current I_{OLED} through the organic light emitting diode 25 is equal to about k(V_{D}−V_{G}+V_{TH}−V_{TH})²/2, that is, the driving current I_{OLED} is equal to about k(V_{D}−V_{G})²/2. Thus, the threshold voltage V_{TH} does not affect the driving current I_{OLED}.

When the scan line 22 outputs a next low level, the first and third switching TFTs 26 and 28 are switched off, and the second switching TFT 27 is switched on. Because the control circuit 20 does not detect the present driving current I_{OLED}, the voltage signal provided by the control circuit 20 to the data line 23 is about equal to the power voltage signal V_{D}. Meanwhile, the capacitor 24 discharges, and provides a control voltage to the gate electrode of the driving TFT 29 to switch on the driving TFT 29, and the value of the control signal is equal to (V_{G}−V_{TH}). The value of the driving current I_{OLED} through the organic light emitting diode 25 is about equal to k(V_{D}−V_{G}+V_{TH}−V_{TH})²/2, that is, the driving current I_{OLED} is equal to about k(V_{D}−V_{G})²/2.

Because the threshold voltage V_{TH} does not affect the driving current I_{OLED}, the pixel circuits 2 that receive the same data signals can obtain similar brightness. Thus, image uniformity of the active matrix OLED device is improved.

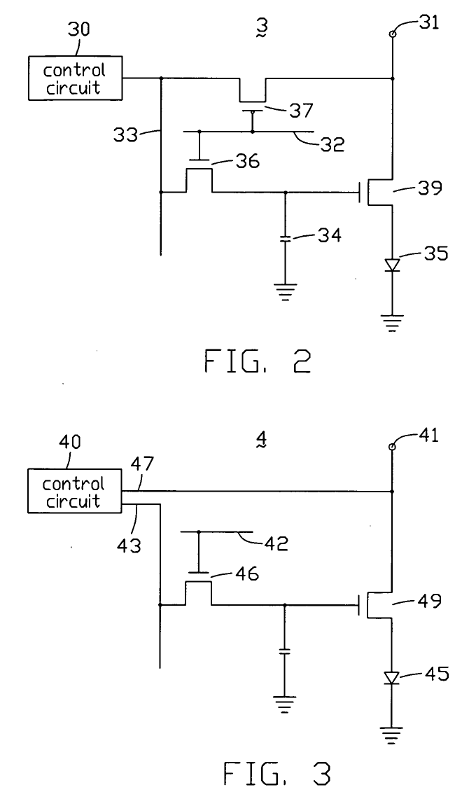

Referring to FIG. 2, a pixel circuit 3 of a second embodiment of an active matrix OLED device according to the present disclosure is shown, differing from pixel circuit 2 only in that pixel circuit 3 includes three TFTs, a first switching TFT 36, a second switching TFT 37, and a driving TFT 39. Gate electrodes (not labeled) of the first and second switching TFTs 36 and 37 are respectively connected to the same scan line 32. A source electrode (not labeled) of the second switching TFT 37 is connected to a control circuit 30, and a drain electrode (not labeled) is connected to a voltage input terminal 31. A source electrode (not labeled) of the driving switching TFT 39 is connected to the voltage input terminal 31, and a drain electrode (not labeled) is grounded via the organic light emitting diode 35.

When a high level first output by the scan line 32 is converted to a low level, the first TFT 36 is switched off, and the second switching TFT 37 is switched on. The voltage input terminal 31 provides a power voltage signal V_{D} to the source electrode of the driving TFT 39. The control circuit 30 detects a present driving current I_{OLED} via a data line 33, and compares the present driving current I_{OLED} to a default value equal to I=k(V_{D}−V_{G})²/2. The control circuit 30 then calculates the threshold voltage V_{TH} according to a difference value between the present driving current I_{OLED} and the default value, and therefore, the data signal applied to the data line 33 needs to be compensated to (V_{G}−V_{TH}). After calculating the difference value, the control circuit 30 stops to detect the present driving current I_{OLED}.

When a next high level is applied to the scan line 32, the first switching TFT 36 is switched on, and the second switching TFT 37 is switched off. The data signal applied to the data line 33 is regulated by the control circuit 30, and has a value of about V_{G}−V_{TH}. The regulated data signal is applied to the drain electrode of the first switching TFT 36 via the data line 33 and the source electrode of the first switching TFT 36 to charge a capacitor 34. The value of the gate electrode V_{G} is equal to about V_{G}−V_{TH}. Meanwhile, the power voltage signal V_{D} is applied to the source electrode of the driving TFT 39, so that a driving current I_{OLED} is transmitted to the organic light emitting diode 35. The value of the driving current I_{OLED} through the organic light emitting diode 35 is about equal to k(V_{D}−V_{G}+V_{TH}−V_{TH})²/2, that is, the driving current I_{OLED} is equal to about k(V_{D}−V_{G})²/2. Thus, the threshold voltage V_{TH} does not affect the driving current I_{OLED}. The pixel circuit 3 can achieve substantially the same effect as the pixel circuit 2 of the first embodiment.

Referring to FIG. 3, a pixel circuit 4 of a third embodiment of an active matrix OLED device according to the present disclosure is shown, differing from pixel circuit 3 of the second embodiment only in that pixel circuit 4 includes two TFTs, a switching TFT 46 and a driving TFT 49. A voltage input terminal 41 provides a power voltage signal V_{D} to a source electrode of the driving TFT 49. A control circuit 40 detects a present driving current I_{OLED}, equal to about k(V_{D}−V_{G}−V_{TH})²/2, via a particular line 47, and compares the present driving current I_{OLED} to a default value that equals to about I=k(V_{D}−V_{G})²/2. The control circuit 40 then calculates the threshold voltage V_{TH} according to a difference value between the present driving current I_{OLED} and the default value, and therefore, a data signal applied to a data line 43 needs to be compensated to about V_{G}−V_{TH}. When a scan line 42 outputs a high level, the switching TFT 46 switches on, and the regulated data signal (V_{G}−V_{TH}) is applied to a gate electrode of the driving TFT 49. The value of the driving current I_{OLED} through an organic light emitting diode 45 is about equal to k(V_{D}−V_{G}+V_{TH}−V_{TH})²/2, that is, the driving current I_{OLED} is equal to about k(V_{D}−V_{G})²/2. Thus, the threshold voltage V_{TH} does not affect the driving current I_{OLED}. The pixel circuit 4 can achieve substantially the same effect as the pixel circuit 1 of the first embodiment.

In addition, the control circuit 40 can continuously detect the driving current I_{OLED}.

It is to be understood that even though numerous characteristics and advantages of the present embodiments have been set forth in the foregoing description with details of the structures and functions of the embodiments, the disclosure is illustrative only, and changes made in detail, especially in matters of shape, size, and arrangement of parts, within the principles of the embodiments, to the full extent indicated by the broad general meaning of the terms in which the appended claims are expressed.

What is claimed is:

1. A pixel circuit of an active matrix organic light emitting diode (AMOLED) device, comprising:
a scan line;
a data line to provide a data signal to the pixel circuit;
a first switching thin film transistor, a gate electrode of the first switching thin film transistor connected to the scan line, and a source electrode of the first switching thin film transistor connected to the data line;
a second switching thin film transistor, a gate electrode of the second switching thin film transistor connected to the scan line, and a source electrode of the second switching thin film transistor connected to the data line;
a capacitor connected between a drain electrode of the first switching thin film transistor and ground;
an organic light emitting diode;
a driving thin film transistor connected between a drain electrode of the second switching thin film transistor and the organic light emitting diode, and a power voltage signal applied to the organic light emitting diode via the driving thin film transistor, to generate a driving current; and
a control circuit connected to the data line, the control circuit to detect a voltage value of the driving current via the data line, and to regulate a voltage value of the data signal according to the voltage value of the driving current.

2. The pixel circuit of claim 1, wherein if the second switching thin film transistor is switched on, the control circuit compares the driving current to a default current value stored therein, and then calculates a threshold voltage of the driving thin film transistor according to a difference value between the driving current and the default value, and regulates the voltage value of the data signal according to the threshold voltage.

3. The pixel circuit of claim 2, wherein if the second switching thin film transistor converts a switching-on state to a switching-off state, the data line outputs a regulated data signal, and a voltage value of the regulated data signal is about equal to a difference value between a gate electrode voltage of the driving thin film transistor and the threshold voltage.

4. The pixel circuit of claim 3, wherein the default current value is equal to about k(V_{D}−V_{G})²/2, wherein k is a conductivity of the driving thin film transistor, V_{D} denotes a voltage value of the power voltage signal, and V_{G} denotes a gate electrode voltage of the driving thin film transistor.

5. The pixel circuit of claim 1, wherein the first switching thin film transistor is an n-channel type semiconductor, and the second switching thin film transistor is a p-channel type semiconductor.

6. The pixel circuit of claim 1, further comprising a third switching thin film transistor, a gate of the third switching thin film transistor connected to the scan line, and the power voltage signal applied to the driving thin film transistor via the third switching element.

7. The pixel circuit of claim 6, wherein the first and the third switching thin film transistors are n-channel type semiconductors, and the second switching thin film transistor is a p-channel type semiconductor.

8. A pixel circuit of an active matrix organic light emitting diode device (AMOLED), comprising:
a scan line;
a data line to provide a data signal to the pixel circuit;
a first switching thin film transistor, a gate electrode of the first switching thin film transistor connected to the scan line, and a source electrode of the first switching thin film transistor connected to the data line;
a capacitor connected between a drain electrode of the first switching thin film transistor and ground;
an organic light emitting diode;
a driving thin film transistor including a gate electrode connected to a drain electrode of the first switching thin film transistor, and a driving current to be applied to the organic light emitting diode via the driving thin film transistor; and
a control circuit connected to the data line, the control circuit to detect a voltage value of the driving current, and to regulate a voltage value of the data signal according to the voltage value of the driving current.

9. The pixel circuit of claim 8, wherein the control circuit compares the driving current to a default value stored therein, and then calculates a threshold voltage of the driving thin film transistor according to a difference value between the driving current and the default value, and regulates the voltage value of the data signal according to the threshold voltage.

10. The pixel circuit of claim 9, wherein a voltage value of the data signal regulated by the control circuit is about equal to a difference value between a gate electrode voltage of the driving thin film transistor and the threshold voltage.

11. The pixel circuit of claim 10, wherein the default value is equal to about k(V_{D}−V_{G})²/2, wherein k is a conductivity of the driving thin film transistor, V_{D} denotes a voltage of the power voltage signal, and V_{G} denotes a gate electrode voltage of the driving thin film transistor.

12. The pixel circuit of claim 11, further comprising a single line connected to the control circuit, and the driving current detected by the control circuit via the single line.

13. The pixel circuit of claim 12, wherein the first switching thin film transistor is an n-channel type semiconductor.

14. The pixel circuit of claim 11, further comprising a second switching thin film transistor, the second switching thin film transistor controlled by the scan line, and the data signal to be applied to the organic light emitting diode via the second switching thin film transistor.

15. The pixel circuit of claim 14, wherein the first switching thin film transistor is an n-channel type semiconductor, and the second switching thin film transistor is a p-channel type semiconductor.

16. The pixel circuit of claim 14, further comprising a third switching thin film transistor, a gate of the third switching thin film transistor connected to the scan line, and the power voltage signal applied to the driving thin film transistor via the third switching element.

17. The pixel circuit of claim 16, wherein the first and the third switching thin film transistors are n-channel type semiconductors, and the second switching thin film transistor is a p-channel type semiconductor.
